(19) United States
(12) Patent Application Publication
(10) Pub. No.: US 2008/0216312 A1
(43) Pub. Date: Sep. 11, 2008

(54) PLUG INSERTION DEVICE AND METHOD

(76) Inventors: Lendell J. Williams, St. Charles, MI (US); Mark L. Bannan, Owosso, MI (US)

Correspondence Address: REISING, ETHINGTON, BARNES, KISSELLE, P.C., P O BOX 4390, TROY, MI, 48099-4390, US

(21) Appl. No.: 12/045,652

(22) Filed: Mar. 10, 2008

Related U.S. Application Data
(60) Provisional application No. 60/905,726, filed on Mar. 8, 2007.
(60) Provisional application No. 61/013,346, filed on Dec. 13, 2007.

(51) Int. Cl. B23P 21/00; B65B 7/28; B65D 39/00

(52) U.S. Cl. 29/773; 53/309; 215/247

(57) ABSTRACT

A plug insertion device for inserting a plug into a container. The device includes sides defining an opening therebetween. The opening receives a plurality of containers having openings at the upper end thereof. A platen having a plurality of insertion pins is pivoted over the sides. A sheet of plugs is positioned over the openings in the containers. The insertion pins engage the plugs and insert them into the containers upon application of a force to the platen. A return spring returns the insertion pins to their retracted position allowing for the removal of the plugged containers.

### CROSS-REFERENCE TO RELATED APPLICATION

The instant application claims priority to and benefit of U.S. Provisional Patent Applications Ser. Nos. 60/905,726 filed Mar. 8, 2007, and 61/013,346 filed Dec. 13, 2007, the entire specifications of which are expressly incorporated herein by reference.

### FIELD OF THE INVENTION

The present invention relates to a plug insertion device for containers such as vials. Further, the present invention relates to a method for inserting plugs into a container as well as a plug for insertion into a container.

### BACKGROUND OF THE INVENTION

Presently, scientists generally use in excess of fifty million containers or glass vials worldwide for genetic or other research using subjects such as fruit flies. Frequently, several vials, for example, one hundred vials, come in a corrugated tray pack arranged in a 10 vial×10 vial array. Each vial has a fruit fly or other research subject placed in the vial and then each vial is plugged or closed off by manually inserting a plug into each vial. That is, individual stopper devices or plugs are placed by an individual into each container or vial.

### SUMMARY OF THE INVENTION

According to one embodiment of the present invention, there is provided a plug insertion device. The device comprises a base for positioning a container. The device further comprises a platen moveably secured to the base. The device further comprises at least one insertion pin extending out from the platen and adapted to insert a plug into the container when the platen is moved relatively to the base.

According to an alternate embodiment of the present invention, there is provided a method of inserting a plug into a container. The method comprises providing a device having a base defining an opening therein. The device further has a platen moveable relative to the base and having at least one insertion pin. At least one container is positioned in the opening. The upper platen is moved relative to the base such that the insertion pin engages a plug and urges the plug into the container.

According to another alternate embodiment of the present invention, there is provided a plug for a container. The plug comprises a base and an annular side wall extending from the base. The side wall defines an opening therein. The plug compresses upon application of a force when being inserted into the container and expands when the force is removed to engage the container.

### BRIEF DESCRIPTION OF THE DRAWINGS

The present invention will become more fully understood from the detailed description and the accompanying drawings, wherein:

FIG. 1 is a perspective view showing a plug insertion device in an open position;

FIG. 2 is a perspective view showing the plug insertion device with the top platen in position for use;

FIG. 3 is a cross-sectional view showing the plug insertion device prior to insertion of the plugs;

FIG. 4 is a cross-sectional view showing the plugs inserted into the vials;

FIG. 5 is a cross-sectional view showing the platen in an open position and removing the plugged containers;

FIG. 6A is a perspective view of an embodiment of a plug;

FIG. 6B is a cross-sectional view of an embodiment of a plug in a vial;

FIG. 7A is a perspective view of an embodiment of a plug;

FIG. 7B is a cross-sectional view of an embodiment of a plug in a vial;

FIG. 8A is a perspective view of an embodiment of a plug;

FIG. 8B is a cross-sectional view of an embodiment of a plug in a vial;

FIG. 9 is a perspective view of a plug in an alternate container; and

FIG. 10 is a perspective view of one embodiment of a sheet of plugs.

### DETAILED DESCRIPTION OF THE PREFERRED EMBODIMENTS

The following description of the preferred embodiment(s) is merely exemplary in nature and is in no way intended to limit the invention, its application, or uses.

Referring to the Figures, a plug insertion device is generally shown at 10. The plug insertion device 10 includes a base generally indicated at 12. The base 12 includes at least a pair of side walls 14. Front 16 and rear 18 walls interconnect the side walls 14. The front wall 16 defines an opening 20. The opening 20 is for receiving at least one and preferably a plurality of containers 22, such as vials. It should be appreciated by those skilled in the art that the plug insertion device 10 may be designed to receive any number of containers as well as containers other than vials. In one embodiment, the opening 20 extends to the side walls 14 and is rectangular in shape.

The front wall 16 includes an upper wall portion 30 that may be fixed to the side walls 14. The upper side wall portion 30 may also include a portion of a vial spacer 24 thereon for positioning and supporting the plurality of vials 22. In such an instance, the vial spacer 24 is framed by the side walls 14, front wall 16 and rear wall 18. The vial spacer 24 may be used to align the vial tray 26. Alternatively, the vials are positioned by the tray engaging the back and/or side walls.

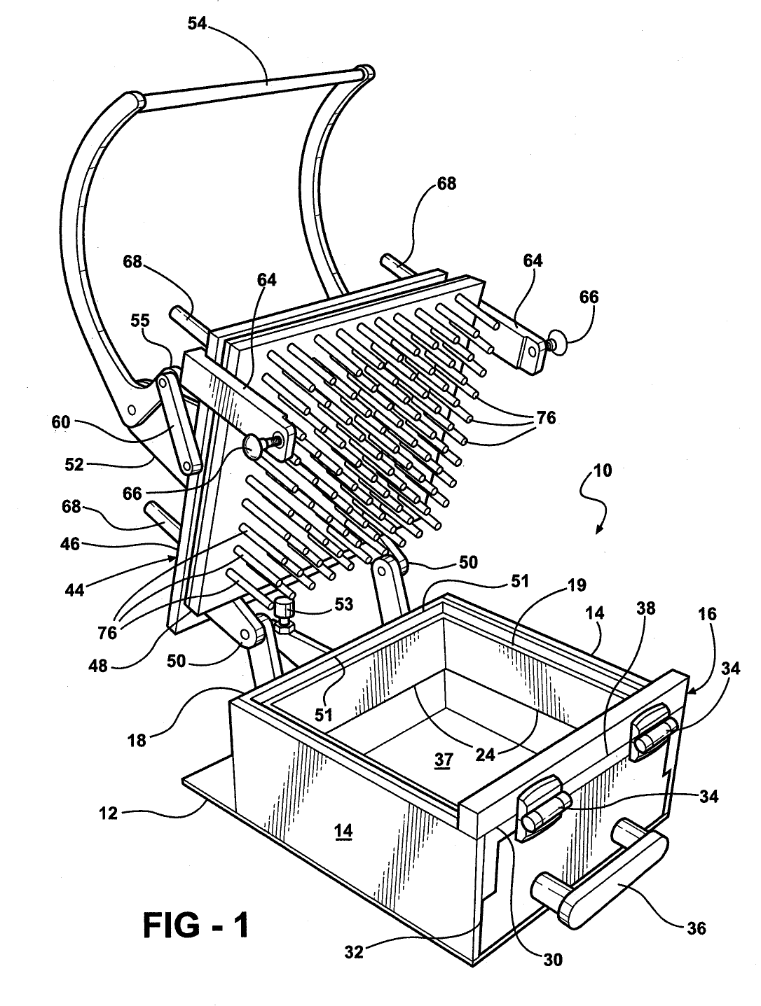

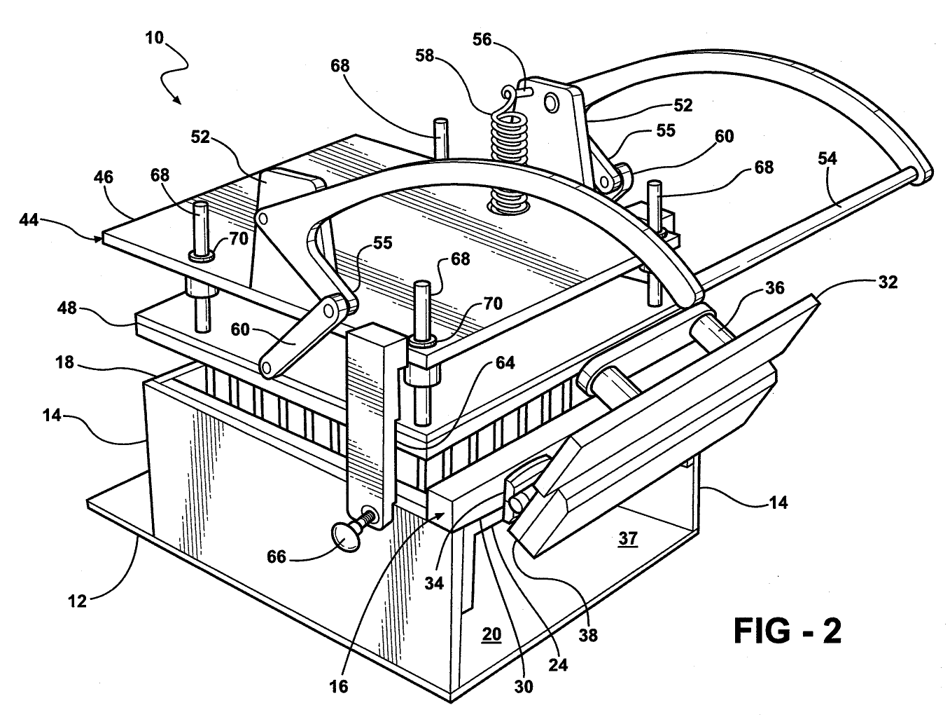

The vial spacer 24 also defines a vial plug rest thereon. The vial plug rest may comprise a lip 19 extending inwardly from the walls toward an interior space 37 as described below. The vial plug rest may be located on each of the side walls 14 and rear wall 18 as well as the upper side wall and portion 30 discussed below. The lip 19 may be used to support a sheet of plugs as will be described below. The front wall 16 further includes a lower movable wall portion 32 that is hinged via hinges 34 to an upper wall portion 30. A handle 36 is connected to the lower movable wall portion 32 so that a user may grasp it and move the lower movable wall portion 32 between closed (FIG. 1) and open (FIG. 2) positions. The lower movable wall portion 32 acts as a door to an interior space 37 of the plug insertion device 10. In the open position, the lower movable wall portion 32 exposes the interior space 37 and the opening 20 and allows a user to insert a tray 26 of containers 22 through the opening 20 and into the interior space 37. It should be appreciated by those skilled in the art that the lower movable wall portion 32 can pivot from either side of the base 12 instead of being hinged from its top edge 38.

The containers or vials 22 are typically contained in the tray 26 as a tray pack that holds the vials 22 in an upright position. Tray packs of this type are well known in the art. Typically, the tray pack 26 holds an array of vials 22, such as a 10×10 array having 100 vials 22. The tray pack 26 holds the vials 22 in an upright orientation. Each vial 22 includes a vial opening 40 at an upper end 42 thereof. Otherwise, the vials 22 are preferably closed. The vials can have any shape. The vial opening 40 of each vial 22 allows items to be placed therein. Once items are placed into the vial 22, it is often desirable to close off or plug the vial opening 40 to prevent egress of the item placed in the vial 22 or ingress of contaminants into the vial 22.

The plug insertion device 10 further includes a platen, generally indicated at 44. The platen 44 has an upper fixed platen member 46 and a lower movable platen member 48. The upper fixed platen member 46 is hinged, via hinges 50 to the rear wall 18. The hinges 50 allow the platen 44 to move between an open position (FIG. 1) and a closed position (FIG. 2). In a descriptive sense, the platen 44 is a top that covers a top access opening 51 that leads to the interior space 37 from above; defined between the side walls 14, the front wall 16 and rear wall 18. When in the open position (FIG. 1), a sheet 86 of plugs 28 can be placed on the lip 19 over the top of the vials 22. A stop 53 prevents the platen 44 from rotating past its open position.

The upper fixed platen member 46 further includes support flanges 52. The support flanges 52 are for supporting a handle 54. The handle 54 extends through a curved path to facilitate the operator to apply a necessary force to the lower movable platen member 48, as will be discussed in greater detail subsequently. The handle 54 includes a bellcrank 55 at its end disposed adjacent the support flanges 52. Pins 56 extend out of each of the support flanges 52. A pair of springs 58 is operatively connected to the pins 56 in the support flanges 52. Each spring 58 is connected between the pins 56 and the lower movable platen member 48. The springs 58 help bias the lower movable platen member 48 toward the upper platen member 46. When the lower movable platen member 48 is disposed adjacent to the upper fixed platen member 46 (when the springs 58 are compressed), it is in its retracted position.

Linkage members 60 are pivotally connected to the handle 54 on each side thereof. Each linkage member 60 is, in turn, rotatably connected to a biasing member 62. The biasing members 62 exert a force on the lower movable platen member 48 to move it away from the upper fixed platen member 46 and downwardly toward the opening 20 in response to a downward force being applied to the handle 54.

A pair of locking members 64 (FIG. 1) extends from the upper fixed platen member 46 downwardly to a position adjacent each side wall 14. A lock pin 66 (FIG. 2) extends through each locking member 64 and is adapted to engage the side wall 14 and in some instances a depression or aperture (not shown) in the side wall 14 to secure the upper fixed platen member 46 with the side wall 14. When the lock pin 66 is in locking engagement with the side wall 14, the upper fixed platen member 46 cannot pivot between the open and closed positions.

Guide rods 68 are secured to the lower movable platen member 48. The guide rods 68 pass through apertures, represented by bushings 70 in the upper fixed platen member 46. The guide rods 68 guide movement of the lower movable platen member 48 as it moves with respect to the upper fixed platen member 46, toward and away from the top access opening 51. As shown, the insertion device may include four guide rods 68.

The platen 44 is described in connection with one embodiment as being pivotally connected with respect to the rear wall 18. It will be appreciated, however, that the upper platen 44 can be connected in any suitable manner to the base 12.

The lower movable platen member 48 may include a plurality of insertion pins 76 thereon. The insertion pins 76 are used to engage a plug opening 78 in a plug 28 to insert each plug 28 into each of the vials 22. The insertion pins 76 further include a plug engaging portion 80. The plug engaging portion 80 comprises a rounded end 82. The rounded end 82 acts on the portion of the plug 28 to be pushed into the vial 22 during insertion, as will be described in more detail below. It will be appreciated that the plug engaging portion 80 can have any suitable configuration. In one embodiment, the plug engaging portion 80 tapers from a base 84 of the insertion pin 76. Further, the length of the insertion pin 76 may be selected to optimize the insertion of the plug 28 into the vial.

The plug engaging portion 80 may have a diameter less than the diameter of the vial opening 40. Further, the insertion pins 76 are secured to the platen 44 in such a manner so as to be generally coaxial with the longitudinal axis of the vials 22 inserted into the opening 20. This allows the insertion pins 76 to extend into the vials 22 to insert the plug 28.

As shown in FIG. 1, one hundred insertion pins 76 are shown. It will be appreciated, however, that any number of insertion pins 76 may be used within the context of the invention and may be placed in any suitable configuration.

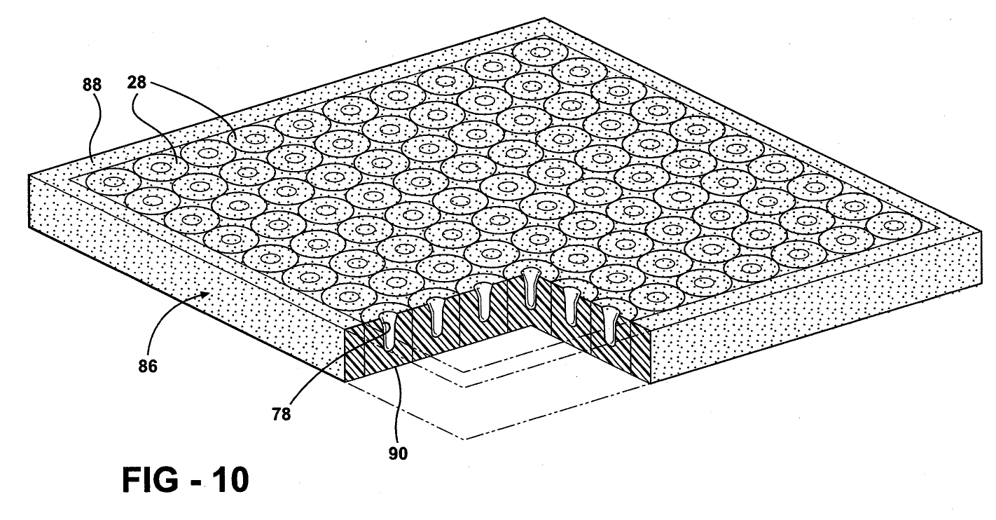

A sheet 86 of plugs 28 (best seen in FIG. 10) is adapted to be supported on the vials 22 within the vial spacer 24. Preferably, the sheet 86 of plugs 28 includes a frame 88 of foam that surrounds the plurality of plugs 28 on four sides. The frame 88 is designed to properly position the plugs 28 when inserted into the plug insertion device 10. The frame 88 may rest on the lip 19 when the sheet 86 is inserted into the device 10. The sheet 86 of plugs 28 is made out of a suitable material than can easily be inserted into the vial opening 40. In one preferred embodiment, the sheet 86 of plugs 28 is made of a suitable foam. The sheet 86 of plugs 28 may includes a plurality of individual cuts 88 to produce score lines that are used to separate the individual plugs 28 from one another. Any suitable procedure can be used to make the score lines. Alternatively, the sheet 86 of plugs 28 may be molded to the desired configuration.

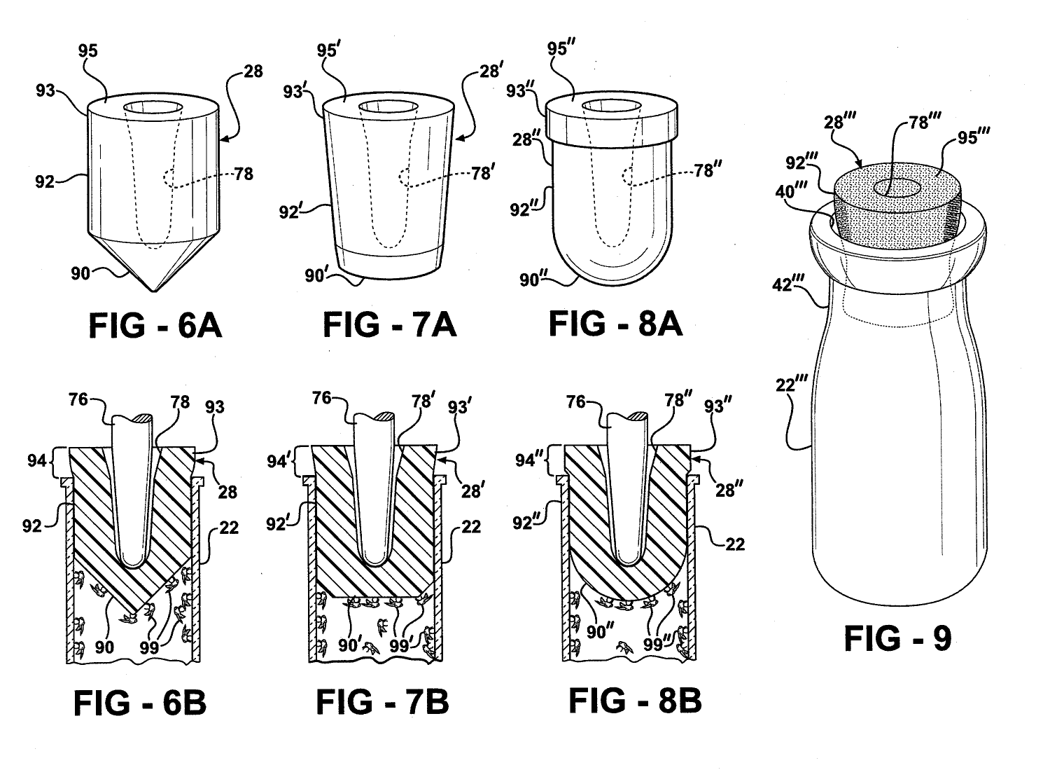

Referring to FIGS. 6A through 8B, wherein like primed reference characters represent similar elements, three alternate embodiments of the plug 28, 28′, 28″ are shown. Each plug 28 is preferably generally cylindrical. Each plug 28 also includes a generally cylindrical aperture therein, the plug opening 78 discussed above. The aperture 78 does not extend the entire length of the plug 28. That is, each plug 28 has a bottom portion 90 with an annular side wall 92 extending from the bottom portion 90. As shown in FIGS. 1-5 and 10, the bottom portion 90 has a generally flat bottom. In the alternative embodiments shown in FIGS. 6-8, the bottom portion 90 is non-linear.

The aperture 78 is defined between the annular side wall 92. It will be appreciated that the annular side wall 92 may taper, such as shown at 92′ in FIG. 7A. The aperture 78 can take any suitable configuration and need not be cylindrical. The aperture 78 can, for example, have a wider diameter toward the top of the plug 28 and a narrower diameter adjacent the bottom portion 90. The bottom portion 90 in each of the plug embodiments varies. It has been determined that when the contents of the vials 22 includes fruit flies 99, it is advantageous to increase the surface area of the portion of the plug 28 exposed to the fruit flies 99. Therefore, the various embodiments shown are designed with the non-linear bottom portion 90 to increase the surface area of the bottom portion 90.

The aperture 78 allows the rounded end 82 of the insertion pin 76 to be inserted therein and to engage the bottom portion 90 of the plug 28. In this manner, the insertion pin 76 pushes on the bottom portion 90 of the plug 28 and causes the remainder of the annular side wall 92 to be pulled into the vial 22 through its vial opening 40. The force of the insertion pin 76 causes each individual plug 28 to separate from the sheet 86. That is, the force of the insertion pin 76 detaches each individual plug 28 from the next adjacent plug 28 and from the frame 88 along the individual cuts 88.

Further, it will be appreciated that each individual plug 28 may have an initial diameter larger than the diameter of the vial 22 and/or vial opening 40. More specifically, the diameter of the bottom portion 90 may be greater than the diameter of the vial 22. Once the plug 28 is disposed in the vial 22, the periphery of the bottom portion 90 and the annular side wall 92 engage the vial 22 to close or plug the vial opening 40 in one embodiment. As the insertion pin 76 pushes the plug 28 into the vial 22 through the vial opening 40, it compresses the plug 28. Once the insertion pin 76 is removed, the plug 28 expands to engage the inner surface of the vial 22. The plugs 28 may have an upper portion 93 at a top surface 95 thereof. In some instances, the upper portion 93 may include an annular flange, such as at 93″ in FIG. 8A

A portion 94 of the annular side wall 92 of the plug 28 may remain outside of the vial 22 after insertion. This portion 94, along with the vial opening 40, provides a convenient way to remove the plug 28 from the vial 22, if necessary. Often, it is necessary to access the vial 22 once the plug 28 has been inserted, for example, to collect data. To remove the plug 28, a user would insert their finger into the aperture 78, while also grasping the portion 94 of the annular side wall 92 that extends outward from the vial. The plug 28 can then be easily removed by pulling the plug 28 from the vial 22.

Use of the insertion device 10 is as follows. The platen 44 is moved to the open position by lifting the handle 36 and pivoting the platen 44 about the hinges 34 (FIG. 1). The lower movable wall portion 32 is pivoted about the hinges 34 to expose opening 20. When in this position, a vial tray 26 is placed in the opening 20 between the side walls 14 and the rear wall 13. Once the vial tray 26 is inserted (positioning of the vial tray 26 may be made via vial spacer 24), the lower movable wall portion 32 is pivoted to the closed position. The vials 22 may be loaded with specimens.

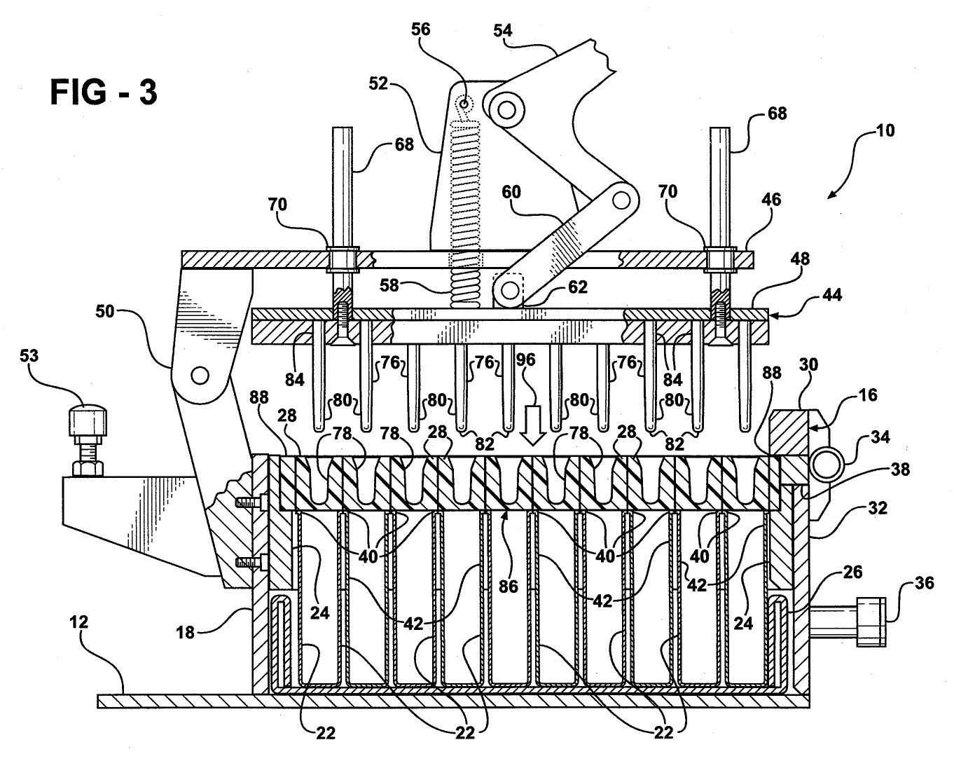

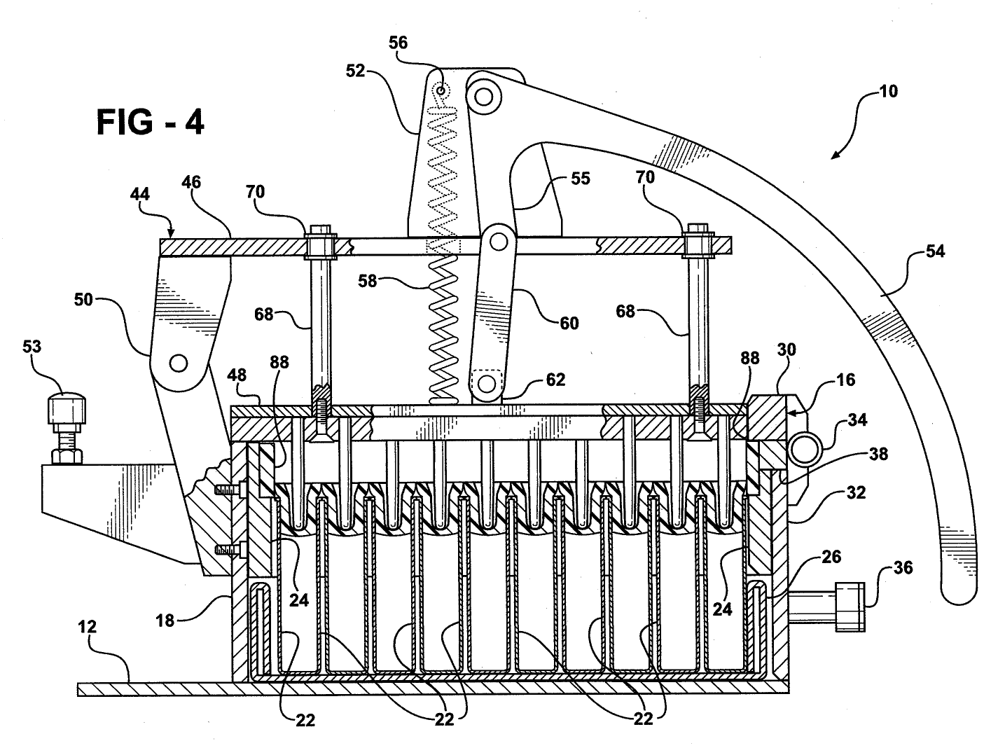

The sheet 86 of plugs 28 is positioned over the tops 40 of the vials 22. More specifically, the sheet 86 of plugs 28 is positioned such that the frame 88 of the sheets 86 rests on lip 19. The platen 44 is then pivoted to the closed position (FIG. 3). The lock pins 66 engage the side wall 14 and perhaps a detent or aperture therein to prevent movement of the upper fixed platen member 46 relative to the side walls 14. A downward force is applied to the handle 36, moving the linkage members 60 and causing the lower movable platen member 48 to move downwardly away from the upper fixed platen member 46. This movement of the lower movable platen member 48 is generally linear. The downward movement causes the insertion pins 76 to move into the plug opening 78, engage each plug 28 and push each individual plug 28 through the vial opening 40 of the vial 22 and into the a vial 22, separating it from the next adjacent plug 28 (FIG. 4). The handle 36 is pushed down until the linkage member 60 reaches the end of its stroke. In this position, the lower movable platen member 48 is moved a sufficient distance to insert the plug 28 into the vial 22.

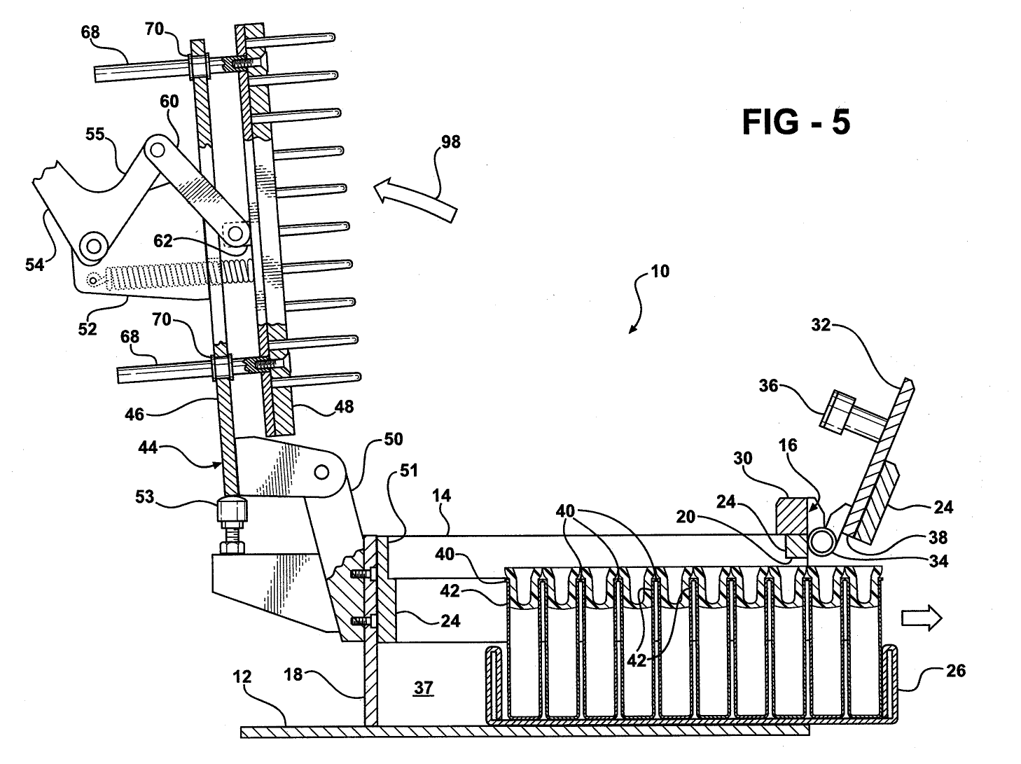

In one embodiment, the upper portion of each plug extends outwardly from the vial after insertion (FIG. 5). This allows for easier removal of the plug from the vial.

Once the plugs 28 are inserted through the vial opening 40 into the vial 22, the handle 36 is moved upwardly. The springs 58 aid in moving the lower movable platen member 48 upwardly out of the opening 20 and toward the upper fixed platen member 46.

The lock pins 66 can then be removed from engagement with the side walls 14. The platen 44 can then be pivoted to the open position (arrow 98 in FIG. 5). The lower movable wall portion 32 can be pivoted to the open position and the vials 22 containing the plugs 28 can be removed from the opening 20. Any remains of the foam sheet 86 can be removed through the top access opening 51. Each vial 22 now contains a plug 28. A new tray containing unplugged vials can then be positioned in the opening 16 and the process repeated.

While the insertion device 10 is described in connection with vials 22, it will be appreciated that any suitable container or vessel may be used within the context of the present invention. Specifically, flasks, test tubes, bottles or any device that has at least one open end can be used within the context of the present invention. In some instances, it may be necessary to include another member (not shown) for aligning the tops of some types of containers. This may be particularly applicable when the base of the container is wider or has a larger diameter than its opening.

It will also be appreciated that while the sheet is preferably foam and each individual plug is made of a foam material, any suitable material may be used for the plug. However, the material should preferably have the ability to be compressed so that it can fit through the opening into the vial and expand so as to form a seal with the interior of the vial 22. Additionally, it is preferred that the foam have a cell structure that minimizes the risk of contamination. For example, when fruit flies are used in a study, it is desirable to eliminate infestation from insects, such as mites. Thus, foam with a micro-cellular structure is desirable. Such a foam and plug may also allow air to pass into the vial while preventing the ingress of undesirable material or the egress of the subject contained in the vial. One such suitable foam is sold under the trade name NOLAPHIL™ which is commercially available from Lendell Manufacturing, Inc. of St. Charles, Mich. The foam plugs can be made by any suitable method. By way of non-limiting example, the plugs, and particularly the sheets of plugs, may be formed from a blank and die cast. Alternatively, the sheets of plugs may be molded.

Further, the plug shown is generally cylindrical having a circular base and annular side wall. It will be appreciated, however and as set forth above, that the plug can have any configuration. For example, the plug can have an octagonal base and a corresponding high side annular wall defining an opening therebetween. The different shaped plugs can provide different sealing characterizations. Any suitable shaped plug is within the context of the present invention. Similarly, the opening in the plug may take any suitable configuration.

While the plug insertion device described herein is used, many plugs can be simultaneously inserted. This saves a user considerable time, particularly when several containers need to be plugged.

Referring to FIG. 9, a fourth embodiment of the plug 28′″ is shown. This embodiment of the plug 28′″ is larger than the plugs 28, 28′, 28″ of the first three embodiments and is designed to be inserted into a container larger than a vial 22. In the Figure, the container is a beaker styled container. The user of the plug 28′″ may force the plug 28′″ into the container 22′″ by pressing down on the top 95′″ thereof. The user may remove the plug 28′″ by pinching the top between the aperture 78′″ and the outer surface 92′″ so that the operator may grab onto the plug 28′″ and pull it away from the top 42′″ of the container 22′″.

The description of the invention is merely exemplary in nature and, thus, variations that do not depart from the gist of the invention are intended to be within the scope of the invention. Such variations are not to be regarded as a departure from the spirit and scope of the invention.

Presently, the preferred embodiments of the invention have been described in an illustrative manner. It is to be understood that the terminology used is intended to be in the nature of words of description. Obviously many modifications and variations are possible in light of the above teachings.

It is to be understood that, within the scope of the appended claims, the invention may be practiced other than as specifically described.

What is claimed is:

1. A plug insertion device comprising:
a base for positioning a container;
a platen moveably secured to said base; and
an insertion pin extending out from said platen and adapted to insert a plug into the container when said platen is moved relative to said base.

2. A plug insertion device as set forth in claim 1 wherein said base includes a lip.

3. A plug insertion device as set forth in claim 1 including a hinge extending between said base and said platen.

4. A plug insertion device as set forth in claim 3 wherein said platen includes an upper fixed platen member fixedly secured to said hinge.

5. A plug insertion device as set forth in claim 4 wherein said platen includes a lower movable platen member disposed adjacent to said upper fixed platen member whereby said lower movable platen member is movable with respect to said upper fixed platen member.

6. A plug insertion device as set forth in claim 5 wherein said insertion pin is fixedly secured to said lower movable platen member.

7. A plug insertion device as set forth in claim 6 including a linkage extending between said upper fixed platen member and said lower movable platen member to provide movement between said upper fixed platen member and said lower movable platen member.

8. A plug insertion device as set forth in claim 7 including a handle pivotally secured to said upper fixed platen member to move said platen with respect to said base.

9. A plug insertion device as set forth in claim 8 wherein said handle includes a bellcrank operatively connected to said linkage.

10. A plug insertion device as set forth in claim 9 including a guide pin extending between the upper fixed platen member and said lower movable platen member to guide movement of said lower movable platen member with respect to said upper fixed platen member maintaining said lower movable platen member parallel to said upper fixed platen member.

11. A plug insertion device as set forth in claim 10 wherein said base includes a front wall, two side walls and a rear wall extending upwardly from said base to define an interior space.

12. A plug insertion device as set forth in claim 11 including a vial spacer extending into said interior space to properly position the container therein with respect to said insertion pin.

13. A plug insertion device as set forth in claim 12 wherein said front wall includes an upper fixed wall portion and a lower movable wall portion whereby said lower movable wall portion is movable to provide access to said interior space.

14. A method of inserting a plug into a container comprising:
providing a device having a base defining an opening therein and a platen movably relative to the base having at least one insertion pin;
positioning at least one container in the opening; and
moving the platen relative to the base such that the insertion pin engages a plug and urges the plug into the container.

15. A method as set forth in claim 14 wherein a plurality of plugs are provided in a sheet, the sheet being positioned in said base such that each plug is positioned over a container prior to the step of moving the platen.

16. A method as set forth in claim 15 removing the platen from a position over the container and plug to remove the container and plug from the device.

17. A method as set forth in claim 14 wherein the platen is moved to urge the plug into the container such that at least a portion of the plug remains outside the container.

18. A plug for a container comprising:
a base;
an annular side wall extending from said base, said side wall defining an opening therein;
wherein said plug is compressible upon application of a force when being inserted into the container and expandable when the force is removed to engage the container.

19. A plug as set forth in claim 16 fabricated from a foam having a micro-cellular structure to allow air to pass therethrough.

20. A plug as set forth in claim 18 wherein said base includes a non-linear bottom portion.

21. A plug as set forth in claim 18 wherein said plug opening is adapted to an insertion pin therein for secure inserting the plug into a container.

22. A plug as set forth in claim 18 wherein said plug includes a flange extending from the annular side wall.
